(19) United States
(12) Patent Application Publication
(10) Pub. No.: US 2008/0294916 A1
(43) Pub. Date: Nov. 27, 2008

(54) Dynamic voltage converter topology switching circuit, system, and method for improving light load efficiency

(75) Inventor: Zaki Moussaoui, Mountain View, CA (US)

Correspondence Address: GRAYBEAL, JACKSON, HALEY LLP, 155 - 108TH AVENUE NE, SUITE 350, BELLEVUE, WA, 98004-5973, US

(73) Assignee: Intersil Americas Inc., Milpitas, CA (US)

(21) Appl. No.: 12/148,787

(22) Filed: Apr. 21, 2008

Related U.S. Application Data
(60) Provisional application No. 60/916,172, filed on May 4, 2007.

(51) Int. Cl. G06F 1/26; H02M 3/157

(52) U.S. Cl. 713/300; 363/71

(57) ABSTRACT

A voltage converter includes a plurality of voltage converter circuits, each voltage converter circuit having a topology, and a control circuit coupled to the voltage converter circuits. The control circuit is operable to select one of the voltage converter circuits to provide an output power on an output node. The control circuit selects one of the voltage converter circuits in response to a parameter associated with the operation of the voltage converter, such as a parameter associated with the output power on the output node.

### TECHNICAL FIELD

Embodiments of the present invention relate generally to power supplies and more specifically to improving the efficiency of power supplies.

### BACKGROUND OF THE INVENTION

Electronic systems include power supplies for receiving an input voltage and converting this input voltage to a desired output voltage that is supplied to components in the electronic system for performing the function of the system. For example, a computer system includes a power supply that receives an input voltage and converts this input voltage to an output voltage that is applied to a motherboard, disk drives, a monitor, and other components of the computer system. Ideally, the power supply operates as efficiently as possible, where efficiency corresponds to the portion of input power received by the power supply that is converted into output power provided by the power supply (i.e., output power/input power).

A variety of different types of power supplies exist, with the particular type utilized in a given application being determined by a variety of different factors such as the amount of power that must be provided and the required efficiency of the power supply. These different types of power supplies have different structures or topologies. One type of power supply is known as a DC-to-DC voltage converter and converts a supplied DC input voltage to a desired DC output voltage. As with any type of power supply, there are many different converter topologies that may be utilized for DC-to-DC voltage converters. The type of DC-to-DC voltage converter selected for a given application is determined, at least in part, by the amount of power to be supplied by the voltage converter. For example, where the amount of power to be supplied by the DC-to-DC voltage converter is less than 100 watts a “flyback” topology may be utilized while a “push-pull” topology may be utilized for output powers from 100 watts to 500 watts and a “full-bridge” topology utilized for output powers greater than 500 watts. One skilled in the art will understand the structure and operation of these and other types of power supply topologies and thus, for the sake of brevity, no detailed discussion of such is provided herein.

The particular topology selected for a voltage converter will typically have an efficiency that varies as a function of how much power the converter is supplying. For example, for a given topology the efficiency of the voltage converter might very significantly for small or “light” loads, meaning conditions under which the converter is providing significantly less output power than it is capable of providing. Take the case of a full-bridge voltage converter which, as previously mentioned, is typically utilized where the output power to be provided is greater than 500 watts. If only 100 watts need be supplied the full-bridge voltage converter can supply this required output power but the efficiency of the converter in doing so may be unacceptably low.

A voltage converter is typically formed in an integrated circuit which a customer integrates into their overall electronic system. At present, such a customer must select the integrated circuit for the voltage converter topology that provides the required maximum output power. Under light load conditions, the selected converter must be operated less efficiently.

There is a need for a voltage converter topology that may be formed in an integrated circuit and which will operate efficiently under both normal and light load conditions.

### SUMMARY OF THE INVENTION

According to one embodiment of the present invention, a voltage converter includes a plurality of voltage converter circuits, each voltage converter circuit having an associated topology, and a control circuit coupled to the voltage converter circuits. The control circuit is operable to select one of the voltage converter circuits to provide an output power on an output node. The control circuit selects one of the voltage converter circuits in response to a parameter associated with the operation of the voltage converter, such as a parameter associated with the output power on the output node.

### BRIEF DESCRIPTION OF THE DRAWINGS

FIG. 1 is a functional block diagram of a topology-switching power supply according to one embodiment of the present invention.

FIG. 2 is a functional schematic diagram of a conventional full-bridge voltage converter that is utilized as one of the voltage converters in the power supply of FIG. 1 according to one embodiment of the present invention.

FIG. 3 is a functional schematic diagram of a conventional symmetrical half-bridge voltage converter that is utilized as one of the voltage converters in the power supply of FIG. 1 according to one embodiment of the present invention.

FIG. 4 is a functional schematic diagram of a conventional single stage power factor corrected voltage converter that may be utilized as one of the voltage converters in the power supply of FIG. 1 according to a further embodiment of the present invention.

FIG. 5 includes a top graph illustrating output voltage of the power supply of FIG. 1 as a function of time and a bottom graph illustrating the load on the power supply as a function of time.

FIG. 6 is a graph illustrating efficiency improvement of the power supply of FIG. 1 achieved through topology switching.

FIG. 7 is a graph illustrating power input of the power supply of FIG. 1 at 50% load.

FIG. 8 is a functional block diagram of an electronic system including electronic circuitry including the power supply of FIG. 1 according to an embodiment of the present invention.

### DETAILED DESCRIPTION OF PREFERRED EMBODIMENTS

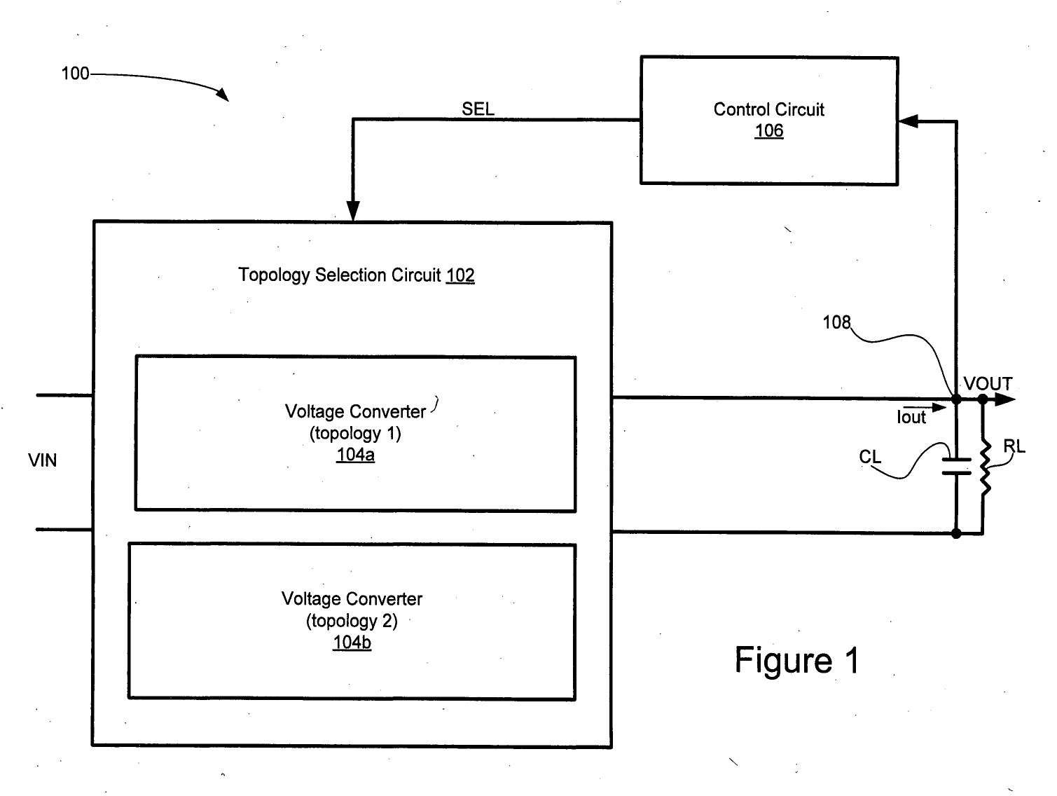

FIG. 1 is a functional block diagram of a topology-switching power supply 100 according to one embodiment of the present invention. The topology-switching power supply 100 includes a topology selection circuit 102 that includes two voltage converter circuits 104a and 104b. A control circuit 106 generates a selection signal SEL in response to a parameter associated with an output power Pout being provided on an output node 108 of the power supply 100. A load being powered by the power supply 100 is represented by a load capacitor CL and a load resistor RL, both of which are coupled to the output node 108. In operation, the control circuit 106 detects the associated parameter of the output power provided on output node 108 and generates the SEL signal to cause the topology selection circuit 102 to select the one of the voltage converter circuits 104a and 104b that will most efficiently supply the required output power Pout, as will be described in more detail below. With the power supply 100, a single integrated circuit containing both voltage converter circuits 104 can be used in applications where the load CL, RL varies such that a single topology converter would operate inefficiently at times. The single integrated circuit also enables only a single component to be manufactured, sold and stocked by customers since this single integrated circuit can be used in applications requiring different power levels.

In the present description, certain details are set forth in conjunction with the described embodiments of the present invention to provide a sufficient understanding of the invention. One skilled in the art will appreciate, however, that the invention may be practiced without these particular details. Furthermore, one skilled in the art will appreciate that the example embodiments described do not limit the scope of the present invention, and will also understand that various modifications, equivalents, and combinations of the disclosed embodiments and components of such embodiments are within the scope of the present invention. Embodiments including fewer than all the components of any of the respective described embodiments may also be within the scope of the present invention although not expressly described in detail below. Finally, the operation of well known components and/or processes has not been shown or described in detail below to avoid unnecessarily obscuring the present invention.

The control circuit 106 may detect more than one parameter and different parameters associated with the output power Pout for use in making the determination of which voltage converter 104a, 104b to activate. For example, in one embodiment the control circuit 106 senses the output current Iout being supplied by the selected voltage converter circuit 104a-b to the load CL, RL along with an output voltage VOUT on the output node 108. In this situation, the detected current Iout and output voltage VOUT correspond to the associated parameter of the output power that is monitored, sensed, or detected by the control circuit 106 Using the detected current Iout and voltage VOUT, the control circuit 106 determines the current output power Pout=Iout×VOUT of the power supply 100. Based on this determination, the control circuit 106 then determines which one of the voltage converter circuits 104a and 104b will operate most efficiently. The control circuit 106 can make this determination in a variety of different ways.

In one embodiment, the control circuit 106 calculates the value of present output power Pout and then determines whether this value is greater than a threshold value PT. The control circuit 106 then generates the SEL signal to activate the voltage converter circuit 104a or 104b that will operate most efficiently at the output power Pout associated with the detected values of current Iout and voltage VOUT. More specifically, when the output power Pout is less than the threshold value PT, the control circuit 106 develops the SEL signal to activate one of the voltage converters 104a, 104b. Conversely, when the output power Pout is greater than the threshold value PT the control circuit 106 develops the SEL signal to activate the other one of the voltage converters 104a, 104b.

In response to the SEL signal, the topology selection circuit 102 activates the appropriate voltage converter circuit 104a or 104b and deactivates the other voltage converter circuit. The selected voltage converter circuit 104a or 104b thereafter generates the required output current Iout to provide the desired output voltage Vout on the node 108 and thereby provides the required output power Pout to the load CL, RL. The selected voltage converter 104a, 104b generates the required output power from an input power source having an associated input voltage VIN, as shown in FIG. 1. Also note that upon power up or restart of the power supply 100 the control circuit 106 develops the SEL signal to cause the selection circuit 102 to activate a default one of the voltage converters 104a, 104b. The converter 104a could always be activated upon power up or restart, with the converter 104b being activated afterwards if necessary depending on required output power Pout.

In other embodiments of the present invention the topology selection circuit 102 includes more than two voltage converter circuits 104. In such embodiments, the control circuit 106 monitors the output power Pout at the node 108 being provided to the load CL, RL, or monitors some other parameter or parameters, and depending upon where this detected output power falls within several ranges of output power the control circuit then generates the SEL signal to cause the topology selection circuit 102 to activate the appropriate voltage converter circuit 104. In one embodiment, for example, the selection circuit 102 includes three voltage converters 104a, 104b, and 104c (104c is not shown in FIG. 1). Assume the voltage converter 104a has a flyback topology, the converter 104b has a push-pull topology, and the converter 104c has a full-bridge topology. Now assume that the converter 104b is the default converter upon power up or restart and that the power supply 100 has just be powered up. If the initial output power Pout is less than 100 watts, the control circuit 106 develops the SEL signal to deactivate the converter 104b and activate the converter 104a. If at a later point in time the initial output power Pout becomes greater than 100 watts, the control circuit 106 develops the SEL signal to deactivate the converter 104a and activate the converter 104b. Now if the output power Pout later exceeds 500 watts, the control circuit 106 develops the SEL signal to deactivate the converter 104b and activate the converter 104c.

Also note that in other embodiments the control circuit 106 monitors or detects different parameters associated with the output power at the node 108. For example, the control circuit 106 detects only the output voltage VOUT or only the current Iout being supplied at the node 108 in other embodiments of the present invention. Furthermore, in other embodiments the control circuit 106 utilizes different processes or algorithms in determining which voltage converter 104 to activate. For example, in one embodiment the control circuit 106 stores data for the efficiency of each voltage converter 104 as a function of output current. In this embodiment, the control circuit 106 senses the output current Iout and then utilizes this sensed current along with the efficiency data for each voltage converter 104 to determine the efficiency for each voltage converter at the current sensed output current. If the efficiency of one of the inactive voltage converters 104 is greater than the efficiency of the currently active voltage converter at the sensed output current Iout, then the control circuit 106 activates the voltage converter having the highest efficiency and deactivates the currently activated voltage converter. If the currently active voltage converter 104 has the highest efficiency, then the control circuit 106 does nothing and in this way the currently active voltage converter continues providing the output current. The control circuit 106 could alternatively generate the SEL signal to control selection of the active voltage converter 104 responsive to other factors determined from the sensed current and voltage or from other sensed parameters, such as efficiency, temperature, and so on.

In one embodiment the voltage converter circuit 104a is a full-bridge voltage converter circuit while the voltage converter circuit 104b is a symmetrical half-bridge voltage converter circuit. In this situation, the control circuit 106 could, for example, generate the SEL signal to select the full-bridge voltage converter circuit 104a when the detected current and voltage indicate output power being provided by the power supply 100 is greater than 500 watts. Conversely, when the control circuit 106 detects the current and voltage indicate the output power being provided by the power supply 100 is less than 500 watts, but control circuit would generate the SEL signal to select the half-bridge voltage converter circuit 104b.

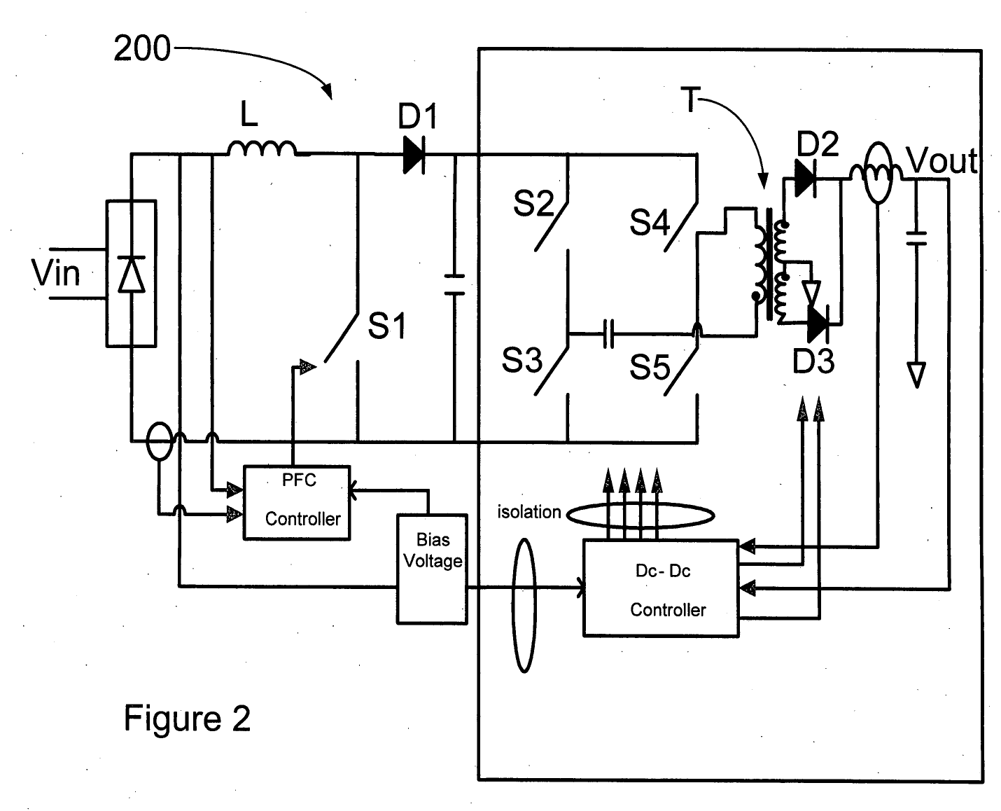

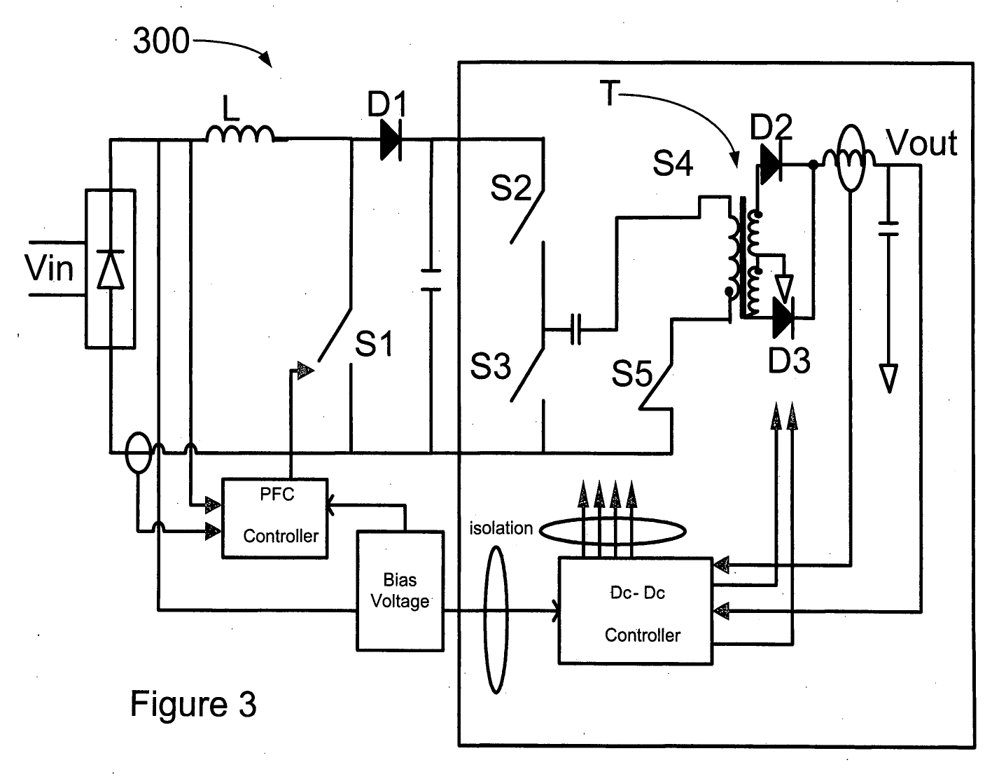

FIG. 2 is a functional schematic diagram of a conventional full-bridge voltage converter 200 that may be utilized as one of the voltage converter circuits 104 in the power supply 100 of FIG. 1. Similarly, FIG. 3 is a functional schematic diagram of a conventional symmetrical half-bridge voltage converter 300 that may be utilized as one of the voltage converters in the power supply 100 of FIG. 1. Both the converters 200 and 300 are conventional circuits and thus, for the sake of brevity, the detailed operation of the circuits will not be described herein since such operation will be understood by those skilled in the art. Briefly, in operation the DC-DC controller in each converter 200 and 300 controls the opening and closing of switches S1-S5 to supply power to a primary winding of a transformer T which, in turn, couples this power to output windings to thereby generate the output voltage Vout from the input voltage Vin.

For high power and high efficiency situations, the control circuit 106 generates the SEL signal causing the topology selection circuit 102 to select the full-bridge voltage converter 200 for operation in generating the output power Pout of the power supply 100. For lower power situations, the control circuit 106 generates the SEL signal causing the topology selection circuit 102 to select the symmetrical half-bridge voltage converter 300 for operation in generating the output power of the power supply 100.

In comparing FIGS. 2 and 3, it is seen that the change in topology from the converter 200 to the converter 300 and vice versa may be accomplished simply through the control of switches S4 and S5 as indicated in both these figures. In this way, a lot of duplicate and additional circuitry need not be required to provide multiple voltage converters 104 in the power supply 100. So in the power supply 100 of FIG. 1, the separate voltage converters 104a and 104b represent different functional modes of operation of circuitry that functions to develop the output voltage Vout using a particular topology, and does necessarily represent separate and independent voltage converter circuits.

Thus, in the converter 200 of FIG. 2 the switches S4 and S5 are controlled to open and close in their usual manner during operation of the converter. When the control circuit 106 determines the output power Pout at the node 108 indicates the converter 300 of FIG. 3 should be utilized, the switch S4 is maintained open and the switch S5 maintained closed. In this way, the topology in FIG. 2 is converted into the topology in FIG. 3. With the converter 300, a transformer T only receives half the voltage it does in the converter 200, meaning a switching frequency at which switches S2 and S3 are turned ON and OFF in the converter 300 may be one half the switching frequency of the switches in the converter 200, as will be appreciated by those skilled in the art.

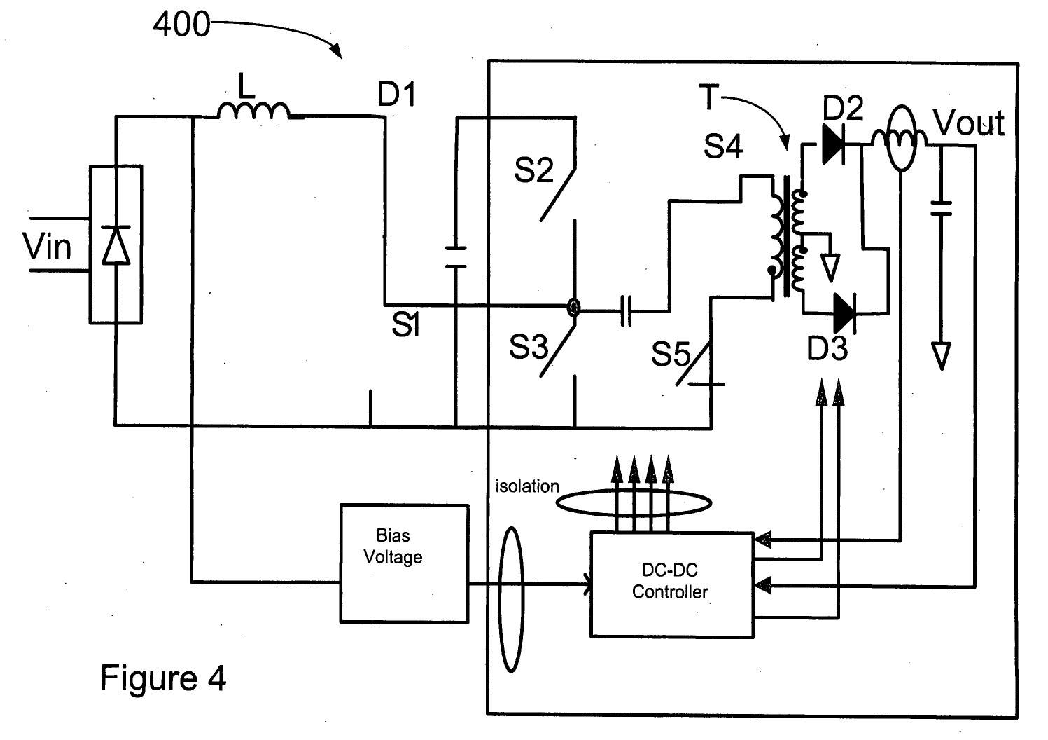

FIG. 4 is a functional schematic diagram of a conventional single stage power factor corrected voltage converter 400 corresponding to the operation of the converter 300 of FIG. 3. This diagram illustrates that during operation of the converter 300 the switches S2 and S3 are running at 50% duty cycle (i.e. one half a switching frequency in the converter 200 of FIG. 2) such that a power factor inductor L is operating in discontinuous mode of operation, which thereby gives natural power factor correction, as will be appreciated by those skilled in the art.

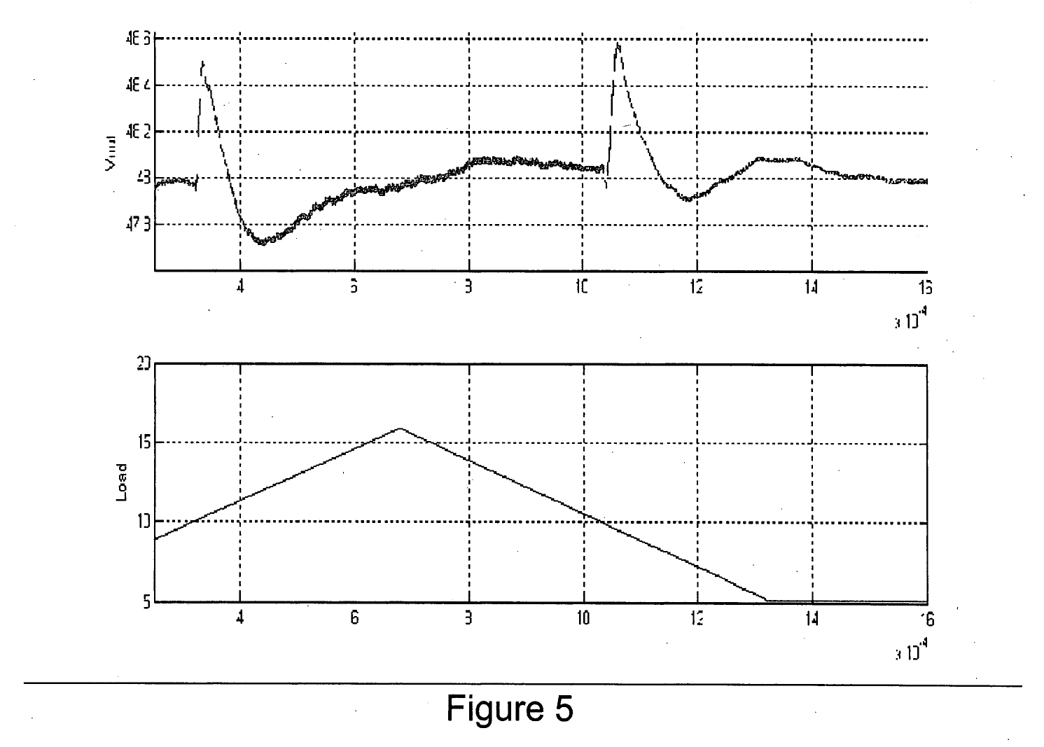

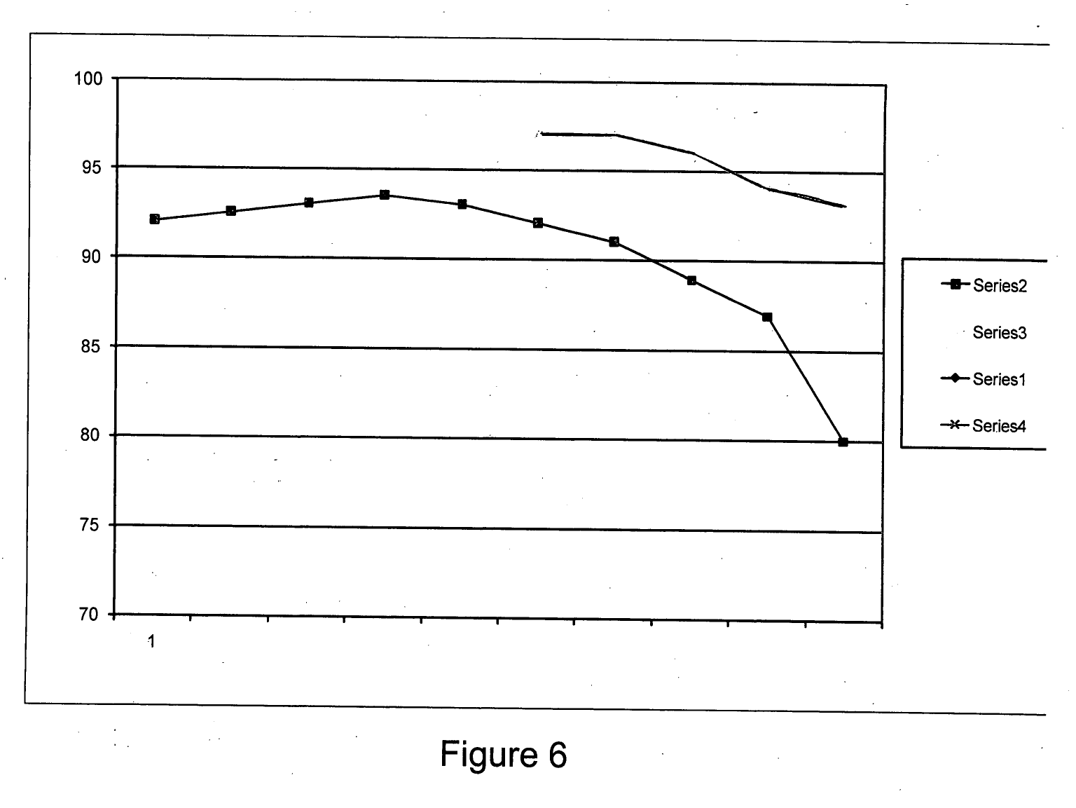

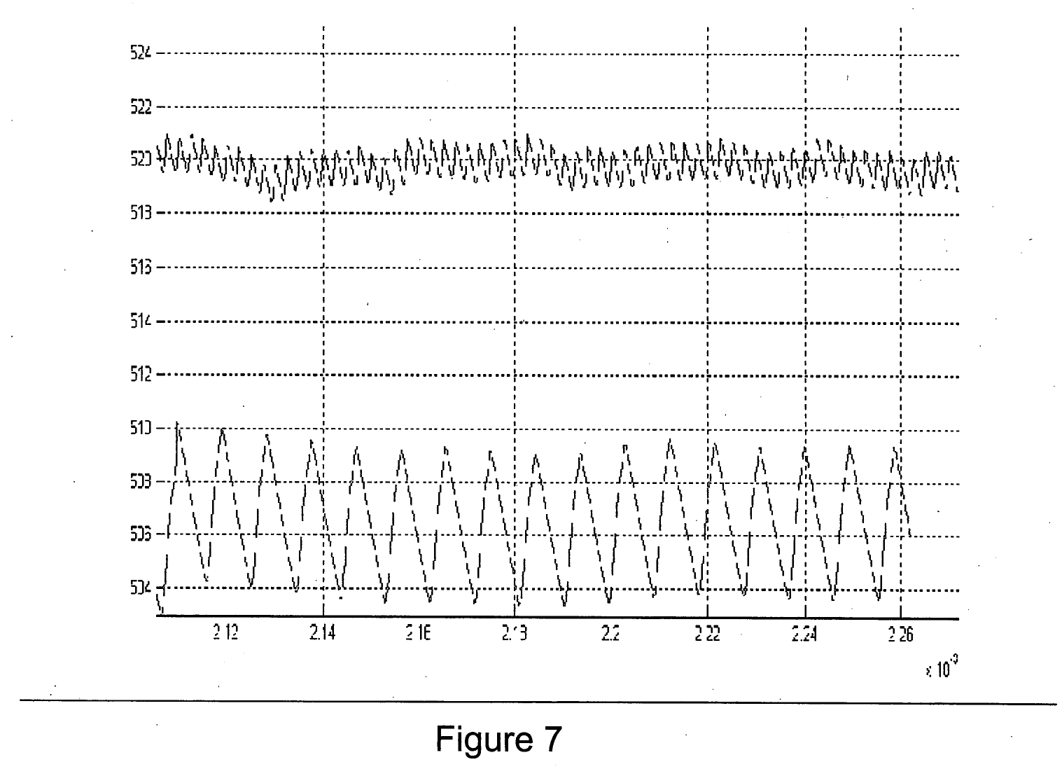

FIG. 5 includes a top graph illustrating output voltage Vout of the power supply 100 of FIG. 1 as a function of time and a bottom graph illustrating current Iout through the load CL, RL on the power supply as a function of time. As seen in these figures, when the current Iout reaches about 10 amps the control circuit 106 (FIG. 1) develops the SEL signal to switch from one voltage converter 104a to the other 104b. This occurs at a time of approximately 2×10⁻⁴ seconds when the current Iout is increasing and again when the current is decreasing at approximately 12×10⁻⁴ seconds. The settling time of the output voltage Vout is seen to happen relatively quickly in the top graph. FIG. 6 is a graph illustrating efficiency improvement of the power supply 100 of FIG. 1 achieved through the topology switching. The upper line illustrates the higher efficiency achieved through switching converter topologies achieved in the power supply 100 of FIG. 1. FIG. 7 is a graph illustrating power input of the power supply 100 of FIG. 1 at 50% load.

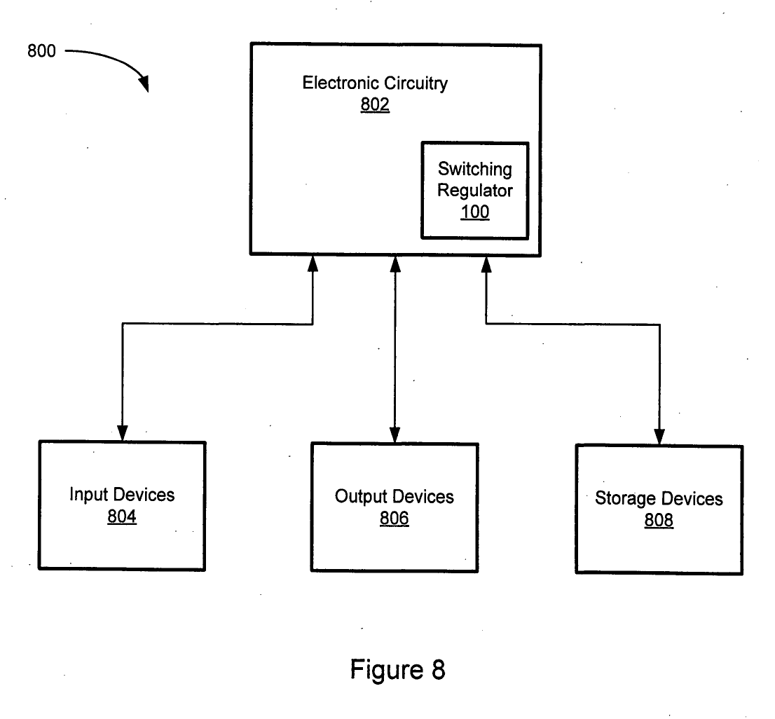

FIG. 8 is a functional block diagram of an electronic system 800 including electronic circuitry 802 including the power supply 100 of FIG. 1 according to an embodiment of the present invention. The electronic circuitry 802 includes circuitry for performing various functions required for the given system, such as executing specific software to perform specific calculations or tasks where the electronic system is a computer system. In addition, the electronic system 800 may include one or more input devices 804, such as a keyboard or a mouse or touchpad, coupled to the electronic circuitry 802 to allow an operator to interface with the system. Typically, the electronic system 800 also includes one or more output devices 806 coupled to the electronic circuitry 802, such output devices typically including a video display such as an LCD display. One or more data storage devices 808 are also typically coupled to the electronic circuitry 802 to store data or retrieve data from storage media (not shown). Examples of typical storage devices 808 include magnetic disk drives, tape cassettes, compact disk read-only (CD-ROMs) and compact disk read-write (CD-RW) memories, and digital video disks (DVDs), FLASH memory drives, and so on.

One skilled in the art will understood that even though various embodiments and advantages of the present invention have been set forth in the foregoing description, the above disclosure is illustrative only, and changes may be made in detail, and yet remain within the broad principles of the invention. For example, some of the components described above may be implemented using either digital or analog circuitry, or a combination of both, and also, where appropriate, may be realized through software executing on suitable processing circuitry. Also, in the same was as described with references to FIGS. 2 and 3 different voltage converter topologies can be utilized and common components controlled to switch between the two topologies or even possibly from among more than two converter topologies in other embodiments of the present invention. The present invention is accordingly to be limited only by the appended claims.

What is claimed is:

1. A voltage converter, comprising:
a plurality of voltage converter circuits, each voltage converter circuit having an associated topology;
a control circuit coupled to the voltage converter circuits, the control circuit operable to select one of the voltage converter circuits to provide an output power on an output node, the control circuit selecting one of the voltage converter circuits in response to a sensed operating parameter of the voltage converter.

2. The voltage converter of claim 1 wherein the sensed operating parameter of the voltage converter is a parameter associated with the output power on the output node.

3. The voltage converter of claim 1 wherein the parameter comprises the output current of the voltage converter.

4. The voltage converter of claim 1 wherein the parameter further comprises the output voltage of the voltage converter.

5. The voltage converter of claim 1 wherein the first voltage converter circuit comprises a full-bridge converter circuit and the second voltage converter circuit comprises a symmetrical half-bridge converter circuit.

6. The voltage converter of claim 1 further comprising additional voltage converter circuits, each additional voltage converter circuit having an associated topology and wherein the control circuit is further operable in response to the parameter associated with the operation of the voltage converter.

7. The voltage converter of claim 1 wherein the sensed operating parameter is a plurality of efficiency versus output power data sets, each data set being associated with one of the voltage converter circuits.

8. The voltage converter of claim 7 wherein the control circuit is operable to sense an output current of the voltage converter and to determine for each voltage converter circuit the corresponding efficiency at the sense output current, and wherein the control circuit is operable to select the voltage converter circuit having the highest efficiency to provide the output power.

9. The voltage converter of claim 1 wherein each voltage converter circuit includes a plurality of switches that are controlled during operation converter circuit to develop the output power, and wherein the control circuit controls some of these switches select the one of the voltage converter circuits having the desired topology, and wherein the control circuit thereafter controls other ones of these switches during operation of the selected voltage converter circuit to develop the desired output power.

10. The voltage converter of claim 1 wherein the control circuit comprises a topology selection circuit that is operable to select one of the voltage converter circuits responsive to a selection signal and to deactivate the remainder of the voltage converter circuits.

11. An electronic system, comprising:
electronic circuitry including a power supply, the power supply including,
a plurality of voltage converter circuits, each voltage converter circuit having an associated topology;
control circuit coupled to the voltage converter circuits, the control circuit operable to select one of the voltage converter circuits to provide an output power on an output node, the control circuit selecting one of the voltage converter circuits in response to a sensed operating parameter of the voltage converter;
at least one input device coupled to the electronic circuitry;
at least one output device coupled to the electronic circuitry; and
at least one storage device coupled to the electronic circuitry.

12. The electronic system of claim 11 wherein the electronic circuitry comprises computer circuitry.

13. The electronic system of claim 11 wherein the input devices include a keyboard or touchpad.

14. The electronic system of claim 11 wherein the output devices include a liquid crystal display.

15. The electronic system of claim 11 wherein the storage devices include a FLASH memory and/or magnetic disk.

16. A method of generating an output power on an output node, the method comprising:
generating the output power on the output node with voltage converter circuitry having an associated topology;
detecting a parameter associated with the output power;
in response to the detected parameter, changing the topology of the voltage converter circuitry to a different topology; and
generating the output power on the output node with the voltage converter circuitry having the different topology.

17. The method of claim 16 wherein generating the output power on the output node with voltage converter circuitry having an associated topology comprises providing a plurality of voltage converter circuits, each having an associated topology.

18. The method of claim 16 wherein the detected operating parameter comprises an output current.

19. The method of claim 18 wherein the detected operating parameter further comprises an output voltage.

20. The method of claim 16 wherein the detected operating parameter comprises a plurality of efficiency versus output power data sets, each data set being associated with one of the topologies.
